(19) United States
(12) Patent Application Publication
(10) Pub. No.: US 2026/0201578 A1
(43) Pub. Date: Jul. 16, 2026

(54) METHOD FOR HANDLING AN ELECTROLYSER STACK AND ELECTROLYSER STACK AND PRODUCTION UNIT

(71) Applicant: thyssenkrupp nucera AG & Co. KGaA, Dortmund (DE)

(72) Inventors: Anders NYGÅRD LAURIDSEN, Kolding (DK); Bo ØSTERLUND MORTENSEN, Kolding (DK); Rasmus ODGAARD WORSØE, Kolding (DK); Henning MORTENSEN, Kolding (DK)

(73) Assignee: thyssenkrupp nucera AG & Co. KGaA, Dortmund (DE)

(21) Appl. No.: 19/134,013

(22) PCT Filed: Dec. 1, 2023
(86) PCT No.: PCT/EP2023/083931

§ 371 Date: May 29, 2025

(30) Foreign Application Priority Data
Dec. 2, 2022 (DK) PA202201093

(51) Int. Cl. C25B 9/73; C25B 1/04; C25B 9/015

(52) U.S. Cl. CPC C25B 9/73; C25B 9/015; C25B 1/04

(57) ABSTRACT

Electrolyser stack and production unit are provided, in which the electrolyser stack include endplates and pull rods extending between the endplates. Feet are arranged at the endplates whereby each foot includes a downwardly directed support surface arranged to abut onto a production unit track or handling unit track whereby the production unit tracks are arranged to extend in parallel with the length axis of the electrolyser stack and whereby the electrolyser stack is movable along the production unit track by sliding the feet along upward facing horizontal slide tracks of the production unit track.

The present invention relates to a method for handling an electrolyser stack. Further, the invention relates to an electrolyser stack and production unit.

### BACKGROUND OF THE INVENTION

The electrolyser stacks in modular electrolyser systems, wherein each module or production unit comprises a plurality of single stacks which are adapted to jointly produce electrolytic products such as hydrogen and oxygen from splitting water, needs to be handled on their own. The need for such handling arises when one or more individual stacks out of a plurality of stacks in a production unit is to be replaced. A method and a production unit for the electrolyser stack, which allows an expedient and un-complicated exchange of individual electrolytic stacks in a production unit comprising a plurality of such stacks is thus provided by the invention.

### SUMMARY OF THE INVENTION

According to the invention, a method for handling an electrolyser stack is thus provided, which method comprises the following steps:
arranging two or more stacks side by side on production tracks in a production unit whereby all stacks and pertaining production tracks are aligned in parallel with each other, and
arranging support feet at least at each end of the stacks and
transferring the entire weight of the stacks onto the production tracks through the support feet and,
providing a force whenever movement of the stack is required and arrange for the force to push and/or pull a single stack in its length axis direction whereby the force slides the stack on the support feet along the production tracks.

As the stacks are arranged side by side in the production unit, it is not possible to handle individual stacks independently from a side thereof and thus, they are to be handled from an end part, and as the stacks are heavy and have a considerable length, lifting by way of a fork-lift or the like from the end part will require a very heavy and expensive vehicle. Further, lifting individual stacks within the unit is not desirable, as such a lifting movement requires an increased building height of the production unit. According to the invention, the stacks shall thus slide in and out of the production unit. To this end stacks are arranged in alignment with production tracks and supported by the tracks, such that the stacks may slide along the production tracks in their length axis direction in and out of the production unit. A force is arranged to this end and adapted to push and/or pull the stack with respect to the tracks and thereby overcome the friction between stack and tracks. The force may originate from an external part such as a vehicle or may come from an inserted actuator between a fixed part, such as a frame element of the production unit and/or a frame part of a handling unit and the stack which is to be moved. If wheels were inserted between support feet and tracks, lesser friction would be observed, however the exchange of a stack is ideally a rare event, and most of the time, the stack shall just sit still in the production unit, and this is a challenge to all wheel bearings. Also, a chemically aggressive environment may reside in the vicinity of the stack due to aggressive chemicals such as oxygen and lye, which could accidentally seep or leek from the stack in some electrolyser processes, notably production of hydrogen from a strong pressurized alkaline solution where pure oxygen is a by-product. The greatness of the invention of the wheel notwithstanding, in the present case surprisingly, a different solution is advantageous.

In an embodiment, the following further steps may be performed:
arranging a handling unit at a first end of a selected pair of production tracks,
aligning the handling unit, such that handling unit tracks extend aligned with and in extension of the production tracks and
causing a stack to move in its length direction along the production tracks and the handling unit tracks by supplying the force onto the stack in its length direction and ensure that the force is bigger than a combined friction force between all of the support feet and the production tracks and/or handling unit tracks.

The handling unit is used to receive or deliver an individual stack, which is pulled and/or pushed from the production unit and onto tracks on the handling unit or vice versa. Thus, initially the handling unit is placed with its track in extension of a pair of production unit tracks and co-axially aligned therewith. In the vertical direction, machine feet arranged between the handling unit and the ground/floor are adjusted to elevate or lover the handling unit track to be level with a pair of production unit tracks. After these simple operations, the force is applied on a stack to either move it into an empty slot in the production unit, or to move a stack from the production unit and onto the tracks of the handling unit. The force is to be arranged co-axially with the length axis of the stack and thereby also co-axially with the two sets of tracks:
the handling unit tracks, and the production unit tracks. If an external force is used, it could well be a forklift, which either pushes or pulls the stack from the production tracks and onto the handling unit tracks or vice versa.

A force provider which is part of or built into either the production unit or the handling unit or both is also possible. This could be a linear actuator or a winch arrangement, either of which could be manually or electrically driven. If a linear actuator with a limited range is used, it could be movably arranged preferably between and below the handling tracks of a handling unit. If a winch is used, it may be arranged at the handling unit, and by way of a turn-wheel at the far side of the production unit, haul the stack away from the handling unit and into the production unit, or by direct connection to an endplate of the stack, the stack may be hauled in the opposite direction from a position inside the production unit and onto the handling unit tracks. Alternatively, the winch is arranged to be moved between a position where it is attached to the distal part of the handling unit and used for hauling the stack out of the production unit and a position where it is attached to the far side of the production unit and used for hauling the stack from the handling unit tracks and into the production unit.

In order to secure the alignment of handling unit and production unit tracks, a mechanical interface, such as a male/female type interface may be provided between the handling unit and production unit. Preferably a male/female type interface is provided, which relies on a vertical movement from above and downward of the handling unit with respect to the production unit. Such an interface may rely on a pair of sturdy downwardly directed plugs on a proximal protruding end of the handling unit adapted to fit snuggly into corresponding holes in a beam of the production unit placed proximal to the production unit tracks. Other types of docking arrangements are possible, relying on moving parts and/or hooks or latches.

In an embodiment, either the handling unit with a stack resting on the handling unit tracks or the stack alone, is moved from a first position to a second position by a wheeled vehicle such as a forklift truck, where either the first or the second position is adjacent to the production unit.

Such movement may be performed without further ado. The handling unit may comprise a pair of tubes adapted to receive the forks of a forklift such that the assembly consisting of a handling unit and a stack may be lifted off the ground and driven to a new location. Alternatively, a couple of slings may be used to hoist the stack off or onto the handling unit, such that the stack alone is moved by a forklift or other truck. In this way, one after the other of a series of stacks may be moved from or inserted into the production unit, or a single stack may be extracted to undergo repair or be replaced.

In an embodiment of the invention, the support feet are arranged as radial protrusions of endplates, where the protrusions are provided with flat surfaces extending along a common horizontal plane with respect to the endplate of each stack and whereby the flat surfaces transfer weight onto corresponding flat horizontal slide tracks, which could also be called skids, on the production tracks or handling unit tracks.

The protrusions of the endplates are preferably provided integrally with the endplates. The slide tracks have machined upper surfaces, and these are honed to a reasonable flatness and well-defined surface roughness which allows the support feet to slide thereon with predefined low friction. To ensure that the weight is evenly distributed between the support feet, they are arranged along a common plane when the endplates are mounted at each their end of a stack. The endplates are sturdy elements made from massive steel, and thus are fit to support the weight of the entire stack through the four support feet. Also, pull-rods are provided to extend between the two endplates of a stack, and due to the high pressure inside the stack, the pull rods must pull the endplates towards each other with a considerable force, which ensures that the stack remains intact with a considerable number of otherwise un-supported individual electrolyser cells resting between the endplates. In an embodiment, friction reducing skates are arranged between the flat surfaces of the radial protrusions and the horizontal slide tracks of the production tracks or production unit tracks.

Skates are provided, preferably as part of the support feet. The skates have a flat side adapted to abut onto a skid and flanges extending downward on each side of the skid. The slide tracks are mounted onto flat support beams and thus have skid surfaces, which are elevated with respect to the beam surfaces. Between the skate and the flat downwardly directed surface of the protruding part of the endplate, a shoe may be arranged, which ensures that the skate stays in place during use. Preferably, bolts with flat heads are used to fasten the skates onto undersides of the shoes. The shoes may be bolted onto the protruding part of the endplate by a through-going bolt, which extend through two flanges of the shoe arranged on either side of the protruding part of the endplate. This arrangement allows for the stack to be hoisted up from a position on the handling unit tracks, while the assembly of shoes and skates remain with the protruding parts of the endplates.

The invention also comprises an electrolyser stack and production unit, whereby the electrolyser stack comprises endplates and pull rods extending between the endplates. According to this aspect of the invention, support feet are arranged at the endplates whereby each foot comprises a downwardly directed support surface arranged to abut onto a production track or handling unit track whereby the production tracks are arranged to extend in parallel with the length axis of the electrolyser stack and whereby the electrolyser stack is movable along the production track by sliding the support feet along upward facing horizontal slide tracks of the production track.

The arrangement of the one or more stacks in the production unit having support feet arranged at the endplates adapted to slide on upwardly facing slide tracks, allows simple and easy transfer of a stack by sliding it along a set of tracks in the production unit. It will be relatively easy to mitigate the friction between the feet and slide tracks, such that easy transfer of electrolyser stacks between the production unit and a freestanding handling unit is obtained. This simply requires that the handling unit is placed in extension of a particular set of production unit tracks such that handling unit tracks extend co-axially and aligned with the production unit tracks on which a stack is placed. Now a simple force applied in the length direction of the stack may slide it on the support feet from one set of tracks onto another.

In an embodiment of the invention, friction reducing skates are arranged between the flat horizontally arranged slide tracks and the undersides of the support feet and are fastened to the support feet and/or to the flat horizontal slide tracks.

The skates may mitigate the size of the force needed to slide a stack along a set of tracks. Preferably the skates are attached to the support feet, but they may also reside as a top surface of the slide tracks on top of the tracks. Preferably the skates are plane pieces of polymer, possibly with friction reducing additives, such as graphite or droplets of oil, or the skates are made from a PTFE based or containing material, or the skates comprise a combination of the mentioned friction mitigating possibilities.

In an embodiment, the support feet are provided as radial protrusions of the endplates.

The endplates are sturdy massive steel parts and may easily support the entirety of the cells with lye arranged between the two plates of a stack.

In an embodiment, the production tracks are part of the production unit, whereby the production unit is adapted to accommodate a multitude of electrolyser stacks to be arranged side by side and with their length axis extending in parallel, and further, the handling unit tracks are arranged as part of a handling unit, whereby the handling unit is adapted to be positioned next to a production unit in order that a single electrolyser stack is slidable between production tracks of a production unit and the handling unit tracks by the application of a force in the length axis direction of the stack.

With these measures, the production unit may hold any number of electrolyser stacks arranged in a single array, while any one of the stacks may be extracted out of the production unit without a need for lifting the stack within the production unit.

In an embodiment, the support feet are arranged at the endplates in pairs, one on each side of a vertical plane extending through a centre length axis of the stack.

When the endplates are arranged with the pull rods to pressurize cell frames from opposing directions, and the electrolyser stack is arranged with a horizontal centreline, there shall be four protrusions, as each endplate have opposed protrusions symmetrically on each side of a vertical line which intersects the centreline. The four protrusions shall have flat surfaces, which are each coplanar with a common horizontal plane. In this way, the support feet may stand on a pair of tracks, which are arranged apart from each other, with a distance therebetween which is equal to the distance between the two support feet on each their side of the vertical centreline.

Various exemplifying and non-limiting embodiments both as to constructions and to methods of operation, together with additional objects and advantages thereof, will be best understood from the following description of specific exemplifying and non-limiting embodiments when read in conjunction with the accompanying drawings.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 is a 3D view of a production unit 19 with a multitude of electrolyser stacks 1,2,3,4,6 arranged therein, and with a forklift truck 14 ready to push a further electrolyser stack 5 into an empty slot 21 in the production unit 19,

FIG. 2 is a plane view from above of the situation shown in FIG. 1,

FIG. 3 is 3D view of an electrolyser stack arranged on a handling unit 15,

FIG. 4 is a close up of a part shown in FIG. 3,

FIG. 5 is a further enlarged 3D view of the support feet 9,10,

FIG. 6 is a view corresponding to the view in FIG. 3, however without a stack on the handling unit tracks 12,

FIG. 7 is a 3D view of a single friction reducing skate 20,

FIG. 7A is a 3D view of a skate 20 as in FIG. 7 adapted for an opposed side foot.

FIG. 8 is a 3D view of a shoe 25, and

FIG. 9 is a 3D view of a winch mounted at the distal part 23 of a handling unit 15.

### DETAILED DESCRIPTION OF THE EMBODIMENTS

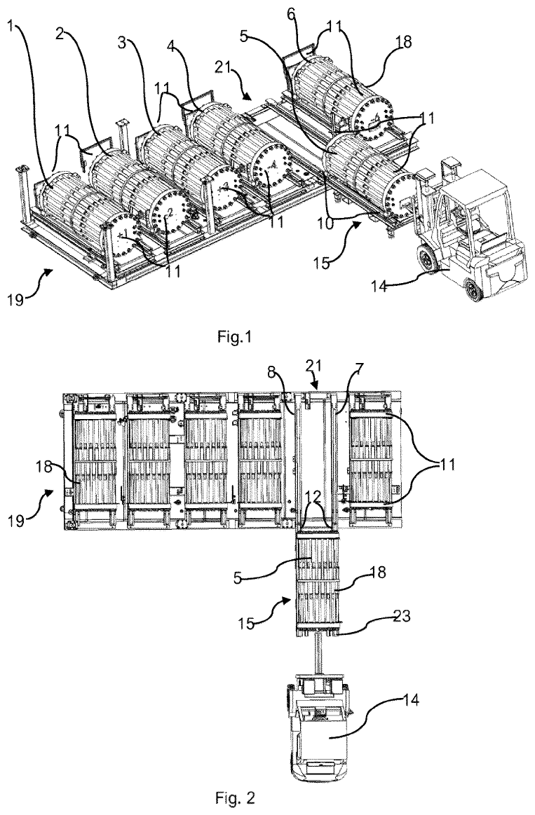

In FIG. 1 and FIG. 2 an array of stacks 1,2,3,4,6 is shown inside a production unit 19. Above and possibly at one or both ends of the array of stacks, further equipment for handling electrolyser products and media are provided (not shown) rendering access to the stacks from above or from an end of the array troublesome. The production unit 19 comprises one or more stacks 1,2,3,4,6 arranged therein and is defined by a common treatment facility adapted to handle electrolyser products from all electrolyser stacks in the unit 19, such as hydrogen and oxygen. The stacks sit side by side in the production unit 19 on a horizontal plane and in parallel as this positioning is advantageous with respect to piping and power connections. An empty slot 21 is visible in FIG. 1 and FIG. 2 and parked outside of the production unit 19, and adjacent to the empty slot 21, a handling unit 15 is seen, and on the handling unit 15 a stack 5 is placed. This stack 5 has either been hauled/pushed out of the production unit 19 or is ready for introduction into the empty slot 21 of the production unit 19.

Below each stack 1,2,3,4,6, a set of production tracks 7,8 are provided in the unit. The tracks 7,8 extend in the full length of the stacks and at one side they are further extended to an outer edge of the production unit 19. At each end of a stack, a pair of support feet 9,10 are provided and adapted to transfer the entire weight of the stack onto the tracks 7,8. The left side support feet 10 and accompanying left side tracks 8 are spaced apart from the right side support feet 9 and tracks 7, and the spacing does not go beyond the diameter of the stack, but corresponds largely to the diameter to thereby provide the best possible support.

When a stack 5 is to be moved out from or into the production unit 19, a force is provided coaxially with the length axis of the stack and hauls/pushes the stack along the tracks 7,8 while the support feet slide along the tracks 7,8.

To remove a stack entirely from the production unit, or to enter a stack into an empty slot therein, a handling unit 15 is arranged in extension of production unit tracks and aligned such that handling unit tracks 12 and production unit tracks 7,8 are co-aligned with each other. Adjustable machine feet 22 may be provided to ensure that handling unit tracks 12 are level with production unit tracks 7,8, while the production unit is also well supported. The needed to be applied onto the stack to move it along the two set of tracks, should ideally be applied in the length axis direction of the stack.

A stack 1,2,3,4,5,6 may be moved individually by a forklift truck, or it may be moved while resting on the handling unit 15, possibly strapped onto the beams of the handling unit. The handling unit is basically a construction comprising 4 beams welded to each other to form a rectangular shape with a length that is at least as long as any stack to be handled by it. The width of the handling unit 15 is commensurate with the diameter of the stacks used in the production unit 19.

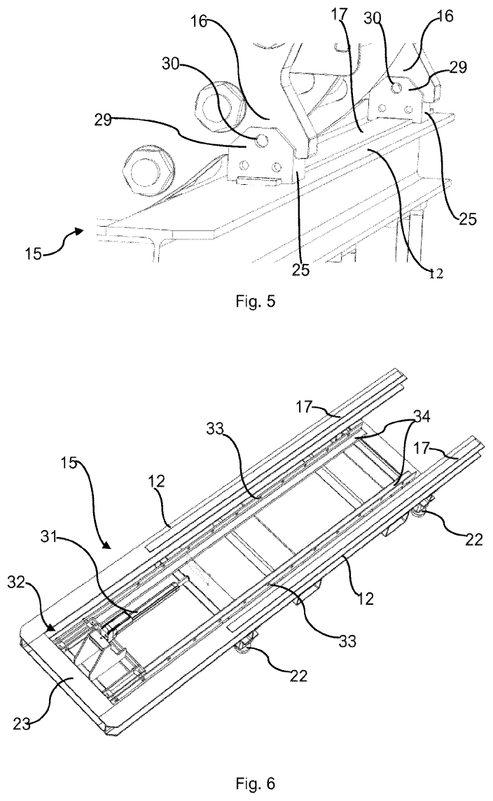

As seen in FIG. 5, the support feet 9,10 are arranged as radial protrusions 16 of endplates 11 of the stack 1,2,3,4,5,6. The radial protrusions have flat downwardly directed surfaces which are arranged within a common horizontal plane (not shown). Through the downwardly directed flat surfaces, the entire weight of the stack is transferred onto the tracks 7,8, 12 whether it be the handling unit or the production unit tracks. In this way each of the feet shall carry ¼ of the entire weight of the stack.

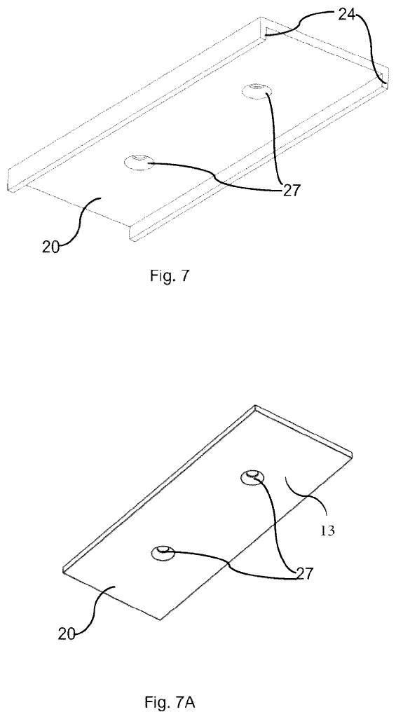

Slide tracks 17 are preferably provided on top of all tracks as best seen in FIG. 6. The slide tracks 17 have upwardly directed surfaces, which are both flat and have a well-defined roughness, such that friction reducing skates 20 mounted onto an underside of the feet may slide on the slide tracks 17 with low friction forces. A single skate 20 is shown in FIG. 7 and FIG. 7A, and as seen, it comprises a flat portion 13 adapted to abut onto the slide tracks 17. In the version shown in FIG. 7, two opposed skate flanges 24 are shown, which are adapted to reside on either side of a skid 17, but the flanges are not part of the version shown in FIG. 7A. By using the two versions on each their respective side of the electrolyser, less sensitivity with respect to tolerances is achieved, both when it comes to the distance between the slide tracks 17 and with respect to the distance between the shoes on either side of a stack.

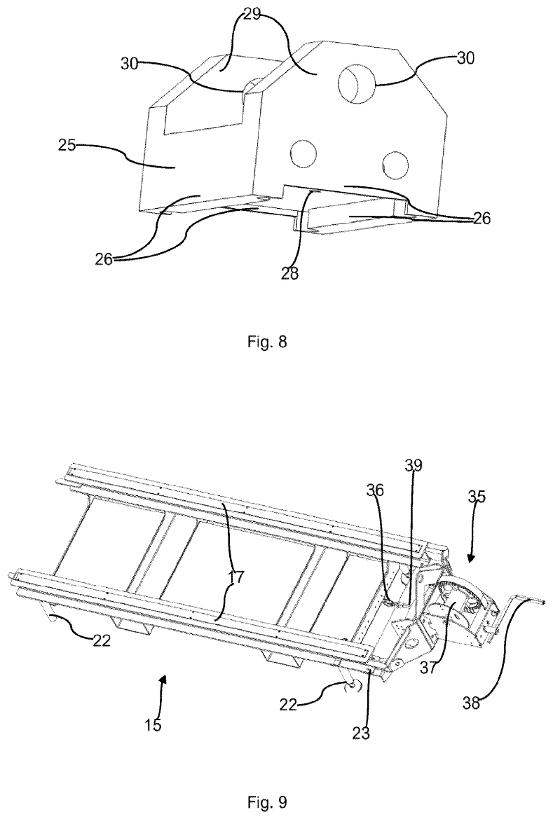

To ensure that the skates 20 remain in place during use, at each of the support feet, a shoe 25 is interposed between the radial protrusion and the friction reducing skate 20, as seen in FIG. 8. The shoe 25 has downwardly directed flanges 26 at all sides adapted to keep a secure grip on all sides of the friction reducing skate 20. Furthermore, the skates 20 may be fastened to the underside of the shoe 25 through flatheaded bolts (not shown) inserted in conical holes 27 in the skates and screwed into threaded holes 28 in the underside of the shoes 25. Upwardly directed flanges 29 of the shoes 25 sit on each their side of the radial protrusions 16 of the endplates 11, and a set of aligned holes 30 are provided through the two flanges 29 aligned with a similar hole in the radial protrusion 16 to which a shoe 25 is attached, such that the two may be fastened to each other by a through-going shaft or bolt (not shown).

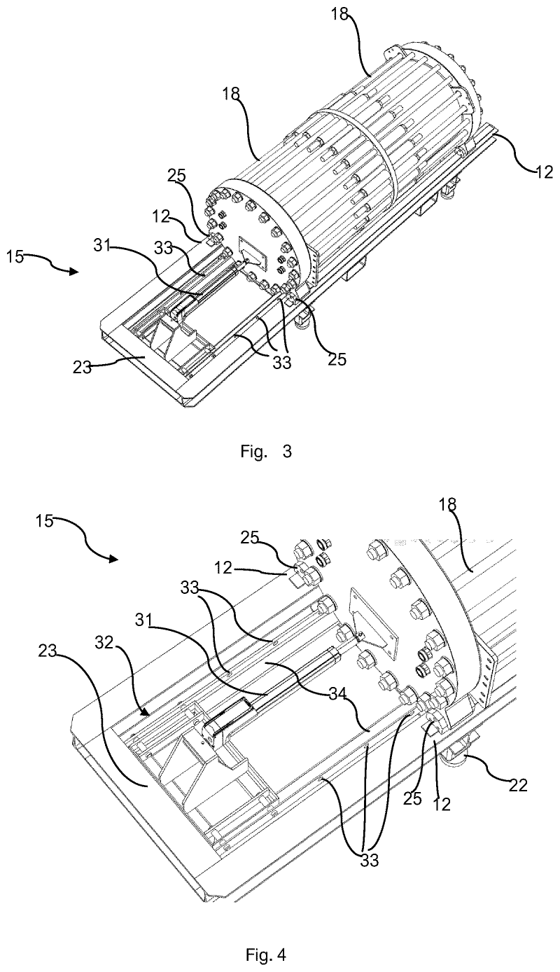

In FIG. 2, a forklift truck 14 is shown, ready to provide a pushing force to move the stack 5 into the empty slot 21 of the production unit 19. In FIGS. 3, 4 and 6, a linear actuator 31 is disclosed, which may push/pull the stack a predefined length along the handling unit tracks 12. As the actuator 31 has limited action range, a movable sledge 32 is provided as counter-hold and anchor point for the actuator. The sledge 32 is arranged on a pair of sledge tracks 34, and the sledge tracks 34 are provided with a range of bolt holes 33 adapted to allow arrest of the sledge 32 at any bolt hole position along the sledge track 34. With this arrangement, it becomes possible to move the stack 5, step by step, into or out of the production unit.

It would alternatively be possible to insert worm drives along the entire length of the stack 5 on the handling unit 15. The worm drives could be arranged approximately at the position where the sledge tracks 34 are shown in FIG. 6 and FIG. 3. The worm drives are essentially just long linear actuates adapted to move a nut or threaded block when drives are rotated. A joint driving mechanism allows simultaneous movement of opposed nuts/blocks along the worm drives, and by adoption of a carrier on each nut/block, a stack may be moved when the two worm drives are rotated. In order to move the stack 5 within the production unit, a similar set of worm drives could be installed in the production unit prior to the planned movement of a stack, such that the drives do not have to reside in the production unit when not in use.

In FIG. 9, a hand-operated winch solution is shown. The winch 35 is shown mounted to a distal end part 23 of the handling unit 15. A wire 39 with a hook 36 attached to it resides on a winch drum 37, and when needed, the wire is wound off the drum 37 and fastened to a stack which resides in the production unit 19 (not disclosed in FIG. 9). Turning of the winch handle 38 will then, through a gearing, turn the drum 37 and rewind the wire onto the drum. This will apply a force to the stack, which followingly is hauled from the production unit track 7,8 and onto the handling unit tracks 12.

The winch 35 may be moved to the side of the production unit opposite the entry/exit side for stacks 1,2,3,4,5,6 to enable a stack being pulled from a position on handling unit tracks 12 outside the production unit and into the production unit 19. In an alternative to the moving of the winch 35 to the back side of the production unit 19, a turn wheel (not shown) for the wire 39 may be arranged here, and the wire 39 may be rewound from the winch drum 37 residing at the distal part of the handling 15, drawn past a stack 5 residing on the handling unit, and along the tracks 7,8 of the production unit, around the turn wheel and back through the production unit and by way of the hook attached to a backend of the stack 5 sitting on the handling unit.

Now, the winch drum 37 may be turned, and the stack hauled towards the turn wheel, away from the winch 35 and into the production unit 19. The turn wheel (not shown) may be stationary or may be a movable device, which can be arranged at the backside of any of the stacks 1,2,3,4,5,6 residing in a production unit of the shown type.

It is to be noted that the figures and the above description have shown the example embodiments in a simple and schematic manner. Many of the specific mechanical details have not been shown since the person skilled in the art should be familiar with these details and they would just unnecessarily complicate this description

### LIST OF PARTS

1 Stack one
2 Stack two
3 Stack three
4 Stack four
5 Stack five
6 Stack six
7 Production unit track, right side
8 Production unit track, left side
9 Support feet, right side
10 Support feet, left side
11 Endplate
12 Handling unit tracks
13 Flat surface of skate
14 Forklift truck
15 Handling unit
16 Radial protrusions
17 Flat horizontally arranged slide tracks
18 Pull rods
19 Production unit
20 Friction reducing skates
21 Empty slot
22 Adjustable machine feet
23 Distal part of handling unit
24 Skate flanges
25 Shoe
26 Downwardly directed flanges
27 Conical holes
28 Threaded holes
29 Upwardly directed flanges
30 Hole in upwardly directed flanges
31 Linear actuator
32 Movable sledge
33 Range of bolt hole
34 Sledge track
35 Winch
36 Hook
37 Winch drum
38 Winch handle
39 Wire

1. A method for handling an electrolyser stack, the method comprising the following steps:
arranging an array of individual stacks side by side on production unit tracks in a production unit whereby all stacks and pertaining production unit tracks are aligned in parallel with each other
arranging support feet at least at each end of the stacks;
wherein the support feet are arranged as radial protrusions of endplates, where the protrusions are provided with flat surfaces extending along a common horizontal plane with respect to the endplates of each stack and whereby the flat surfaces transfer the entire weight onto corresponding flat horizontal slide tracks on the production unit tracks or handling unit tracks; and
providing a force whenever movement of the stack is required and arrange the force to push and/or pull a single stack in the length axis direction whereby the force slides the stack on the support feet along the production unit tracks.

2. The method for handling an electrolyser stack according to claim 1, wherein the following further steps are performed:
arranging a handling unit at a first end of a selected pair of production tracks;
aligning the handling unit, such that handling unit tracks extend aligned with and in extension of the production unit tracks; and
causing a stack to move in its length direction along the production unit tracks, and the handling unit track by supplying the force onto the stack in its length direction and ensure that the force is bigger than a combined friction force between all of the feet and the production tracks, and/or handling unit tracks.

3. The method for handling an electrolyser stack according to claim 2, wherein either the handling unit with a stack resting on the handling unit tracks, or the stack alone, is moved from a first position to a second position by a wheeled vehicle such as a forklift truck, where either the first or the second position is adjacent to the production unit.

4. (canceled)

5. The method for handling an electrolyser stack according to claim 1, wherein friction reducing skates are arranged between the flat surfaces of the radial protrusions and the horizontal slide tracks of the production unit tracks or handling unit tracks.

6. An electrolyser stack and production unit, whereby the electrolyser stack comprise endplates and pull rods extending between the endplates characterized in that, feet are arranged at the endplates, wherein the feet are provided as radial protrusions of the endplates, where the protrusions are provided with flat surfaces extending along a common horizontal plane with respect to the endplates of each stack, whereby each foot comprises a downwardly directed support surface arranged to abut onto a production track or handling unit track whereby the production unit tracks are arranged to extend in parallel with the length axis of the electrolyser stack and whereby the electrolyser stack is movable along the production unit track by sliding the feet-along upward facing horizontal slide tracks of the production unit track.

7. The electrolyser stack and production unit according to claim 6, wherein between the flat horizontally arranged slide tracks and the undersides of the feet, friction reducing skates are arranged and fastened to the feet and/or to the flat horizontal slide tracks.

8. (canceled)

9. The electrolyser stack and production unit according to claim 6, wherein the production unit tracks are part of the production unit, whereby the production unit is adapted to accommodate a multitude of electrolyser stacks to be arranged side by side and with their length axis extending in parallel, and that handling unit tracks are arranged as part of a handling unit, whereby the handling unit is adapted to be positioned next to a production unit in order that a single electrolyser stack is slidable between production tracks of a production unit and the handling unit tracks by the application of a force in the length axis direction of the stack.

10. The electrolyser stack and production unit according to claim 6, wherein the feet are arranged at the endplates in pairs, one on each side of a vertical plane extending through a centre length axis of the stack.
